(19) United States
(12) Patent Application Publication
(10) Pub. No.: US 2002/0023049 A1
(43) Pub. Date: Feb. 21, 2002

(54) Method of procuring financial products

(76) Inventor: O. James Peterson IV, Charlotte, NC (US)

Correspondence Address: ROBERT H. HAMMER III, P.C., Suite 250, 13777 Ballantyne Corporate Place, Charlotte, NC, 28277, US

(21) Appl. No.: 09/896,068

(22) Filed: Jun. 29, 2001

Related U.S. Application Data
(60) Provisional application No. 60/218,393, filed on Jul. 14, 2000.

(51) Int. Cl. G06F 17/60

(52) U.S. Cl. 705/37; 705/1

(57) ABSTRACT

The present invention is directed to a method for an entity, a governmental or business entity, to procure a financial product from a financial institution. The method includes the steps of: posting an entity's request for a proposal (RFP) for the financial product to a website, the RFP having been authorized by an official of the entity; electronically notifying the financial institution that the RFP has been posted; reviewing the RFP by the financial institution; and electronically notifying the entity of a result of the review by the financial institution.

### CROSS-REFERENCE TO A RELATED APPLICATION

The present invention claims the benefit of U.S. Provisional Application No. 60/218,393 filed Jul. 14, 2000.

### FIELD OF THE INVENTION

The present invention is directed to a method for an entity, e.g., a governmental or business entity, to procure a financial product from a financial institution.

### BACKGROUND OF THE INVENTION

Heretofore, governmental and business entities, who were in need of financial products, were required to seek out financial institutions, who may be willing to provide those financial products, and to request proposals for those products through those institution's varied processes. This procedure is time consuming and expensive. It is time consuming because each financial institution is likely to have similar, but different, information needs to consider the request. The entity, therefore, may have to customize its request for each particular institution. It is expensive because the entity would have to maintain a staff to prepare such requests, and the institution would have to maintain a staff to review, analyze, and respond to those requests. Improvement to this procedure could stimulate competition for financial products offered to such entities.

To facilitate understanding, the following discussion will be directed to the specific example of a governmental entity, e.g., a municipality, county, agency, nonprofit organization, or the like, and a financial institution, e.g., a bank, insurance company, financing company, of the like.

When a governmental entity needs a financial product, it may obtain them from a financial institution. The governmental entity usually has a fiduciary duty to the tax-paying public, so it must ensure that it procures the best financial product. To do this, the governmental entity usually sends Request For Proposals (RFP) to several financial institutions. The RFP describes the type of financial product needed and requests a bid for the product, usually by a date certain. All bids received by that date certain are then opened and reviewed by the governmental entity, and the “best” product is chosen. This procedure is, not only, inefficient, in both time and money, it may not provide the governmental entity with the “best” product that would be available, if this procedure was more open and available to a broader market.

To better understand this procurement procedure, lets consider the participants of the entity and the institution. The entity typically has both a finance officer and a manager, the officer being subordinate to the manager. The officer is responsible for generating the RFP, obtaining bids, reviewing the bids, and making a recommendation about which bid is “best.” The institution typically has a relationship manager, a credit administrator, and a market executive. The relationship manager ensures that the entity receives a sound level of service and that the relationship is enhanced by the institution's opportunity to serve. The credit administrator assesses the soundness of any debt or credit risk associated with the bid and the product offered to the entity, and ensures that the institution receives adequate compensation for the offered product. The market executive ensures that the bid is competitive in the market.

This procurement procedure is slow and inefficient. For example, it is generally paper-based and document intensive. On the entity side, it requires typing an RFP, generating a mailing list, printing the RFPs and envelopes, mailing RFPs, receiving and answering questions from each financial institution, waiting for bids, reviewing the bids, creating a comparative outline for analyzing the bids, presenting findings and recommendations to the manager and/or board of the entity, and then notifying the financial institution which submitted the “winning” bid. On the financial institution side, it requires finding an underwriter for the request, providing the underwriter with historical and current financial information about the entity, soliciting questions and answers from the entity's finance officer, analyzing the credit of the entity, researching market pricing, agreeing to the underwriter's recommendation, presenting that recommendation to credit administrator, obtaining the credit administrator's approval through justification of both credit and pricing, soliciting market executive's input, coming to final agreement on the package, typing out the bid, and mailing out the bid in time for the date certain. This procedure can often take as many as 15 to 30 days for a governmental entity to be able to source a financial product, and some products are so complex that the governmental entity never even undertakes this procedure, or do so only infrequently (e.g., every three to five years). Further, because this procedure is undertaken so infrequently, the entity has to relearn the procedure each time, thereby wasting tax dollars and further slowing the process.

This procedure is expensive. For example, the traditional business model used by financial institutions for a commercial entity, i.e., a non-governmental entity, includes a dedicated relationship manager, a credit administrator, and a market executive for each commercial customer and for each request made by that commercial customer. This model is expensive because of the staff needed for the underwriting process, as well as, the interaction required to execute a credit and pricing decision. The model for the governmental entity is usually even more expensive. The higher costs are due to several factors. First, the frequency of receiving RFPs from governmental entities, especially the same governmental entity time after time, is not high enough to warrant a dedicated group at most financial institutions. Second, government entities use fund accounting, to which commercial officers are rarely exposed. These two factors require a learning curve for each time an RFP is made. Third, monetary values are generally high in comparison to commercial customers, thus requiring multiple credit authority levels, which means more individuals than the average commercial decision. Lastly, government requests involve public revenue streams and collateral, which brings some additional legal considerations to the credit decision, thus requiring higher-than-ordinary legal counseling and advice.

This procedure provides no economies of scale for either the governmental entity or the financial institution. For example, governmental entities are often presented with a limited available market of bids because it is often too costly and cumbersome for financial institutions even to respond to an RFP, especially when the size of such deals may not be large enough to justify much time and energy being devoted to the process. Further, due to the limited staffing common with most smaller governments, the finance officer tends to “wear more hats” and is burdened with a workload that often distracts him from one of his direct responsibilities, namely, obtaining the lowest pricing for financial services.

Accordingly, there is a need to improve this procurement process.

U.S. Pat. No. 5,915,209 discloses a bond trading system. This system is used in the business of trading bonds, including municipal bonds. The system provides a remedy to difficulties encountered by municipal bond brokers in obtaining accurate and detailed information on municipal bond lots and sales while the transactions are occurring.

U.S. Pat. No. 6,161,099 discloses a system for conducting auctions, i.e., municipal bond auctions, over the Internet. The system interconnects, via the Internet, an auctioneer and several bidders, so that an auction may be conducted over the Internet.

U.S. Pat. No. 6,233,566 discloses an online centralized financial products exchange system. This system is used by a “borrower/consumer-person (homeowner)” to obtain a financial product from a financial institution. Also see www.lendingtree.com.

Way2bid, Inc. (www.way2bid.com) offers an Internet-based sealed bid auction technology. This system is used by entities, governmental or businesses, to obtain products, but not financial products, from vendors. Also see Advantiv, Inc. (www.advantiv.com) and Decision Director (www.decisiondirector.com).

Nothing in the prior art solves the problem set out herein.

### SUMMARY OF THE INVENTION

The present invention is directed to a method for an entity, a governmental or business entity, to procure a financial product from a financial institution. The method includes the steps of: posting an entity's request for a proposal (RFP) for the financial product to a website, the RFP having been authorized by an official of the entity; electronically notifying the financial institution that the RFP has been posted; reviewing the RFP by the financial institution; and electronically notifying the entity of a result of the review by the financial institution.

### DESCRIPTION OF THE DRAWING

For the purpose of illustrating the invention, there is shown in the drawing a form which is presently preferred; it being understood, however, that this invention is not limited to the precise arrangements and instrumentalities shown.

FIG. 1 is a flow diagram of the present invention.

### DESCRIPTION OF THE INVENTION

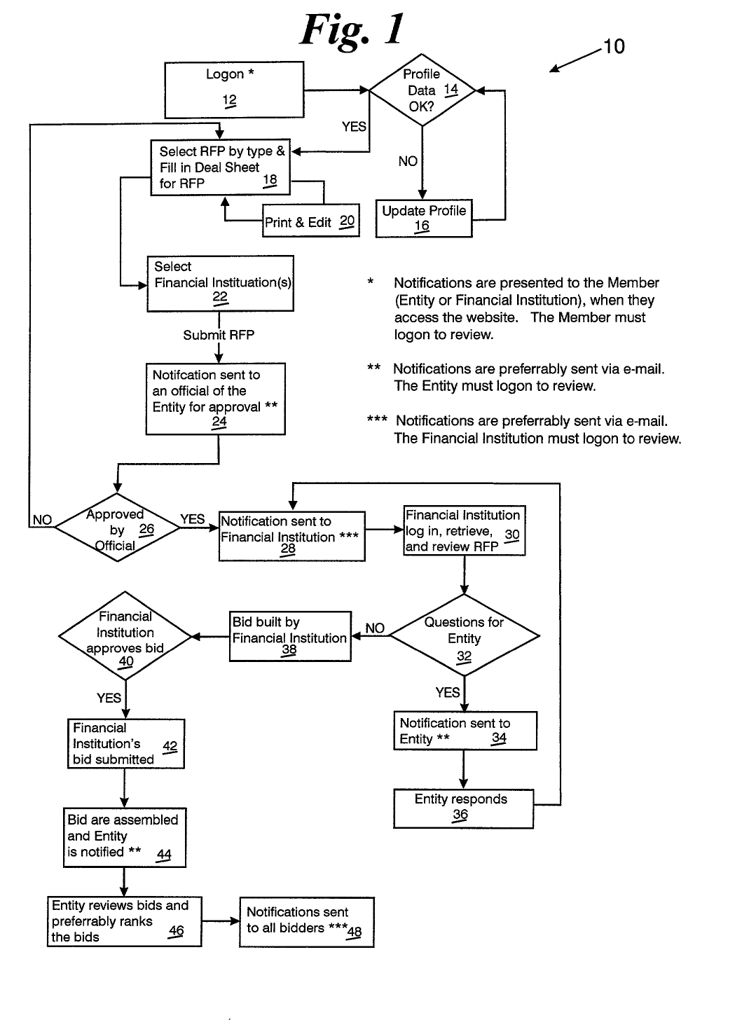

Referring to FIG. 1, there is shown a flow diagram setting forth the method of procuring financial products 10. Method 10 is a web-based solution to the above-mentioned problem. The method 10 is intended to be implemented via a website. The website is preferably a secure website, so that privacy of the member is maintained. Members, e.g., financial product sellers (e.g., financial institutions) and financial product buyers (e.g., entities, governmental or business entities, and preferably excluding individuals) would access the method 10 by logging onto the website 12. When the members identify themselves at the website, the member may receive messages, which are only retrievable by logging on.

Each member shall preferably have a profile 14. The profile contains standard information about the member including, but not limited to, name, address, contact information, key individuals, organizational structure, historical data (e.g., income statements, balance sheets, trend financial summary, ratio analysis, credit rating, product pricing, previous RFP submitted, prior products procured). The member shall have the ability to periodically review and update information 16 in the profile 14. The profile may also contain preferential information about the member including, but not limited to, preferred business partners (e.g., financial institutions).

The method is usually initiated by the entity. The entity, after logging on and, if necessary reviewing and modifying their profile, selects the type of financial product (discussed below) desired. Selection may be facilitated by “drop down buttons” that provide financial product choices. Each financial product will have a “deal sheet” 18. The deal sheet outlines, at least, a minimum amount of information that the financial institution shall require to evaluate the entity's RFP. Some of that information may be available from the entity's profile 14 and could be automatically entered onto the deal sheet. Other information would have to be entered by the entity. After completion of the deal sheet, it may be printed off and reviewed 20. It is contemplated that completion of the deal sheet is the responsibility of the entity's financial officer.

The entity may then select 22 which financial institutions that it wishes to receive the RFP.

The RFP must be approved by the entity before it is released to the financial institutions. After completion of the deal sheet, a notification 24 is sent to the entity, specifically, the official of the entity with oversight responsibility. That official reviews the RFP and authorizes 26 its release to the financial institutions.

A notification 28 is sent to the financial institution. The notification informs the financial institution that an RFP is available for retrieval at the website. The RFP is, preferably, not sent directly to the financial institution after approval by the official, but instead, it is held and must be retrieved by the financial institution.

The financial institution logs onto the website 30, retrieves the RFP and begins its review of the RFP. If after the initial review the financial institution believes that further information is needed to fully evaluate and respond to the entity, it may solicit such additional information 32. The institution prepares the questions and preferably submits them to the entity via the website. Once the questions are at the website, the entity is notified 34. The entity responds to the questions 36, preferably via the website.

The financial institution builds 38 its bid. After completion of the bid, the institution, pursuant to its internal procedures, approves the bid 40. Thereafter, the bid is preferably released to the website 42.

At the website, the various bids from several financial institutions are preferably assembled 44 in a format to facilitate the entity's review and selection of the various bids. The assembled bids, as well as, the individual bids, are presented 46 to the entity.

The entity selects the “best” bid, pursuant to its internal procedures. The winner is notified preferably via the website 48.

The process outlined below is an example of the inventive method as applied to a Small Issuer Financing RFP. This product is one of the most time consuming and detailed; however, the fundamental process is the same for all types of financing products that could be used with the present invention. The below example compares the traditional process with that of the present invention, not only in steps but also in average amount of time (hours: minutes) for each step.

### Full Process Breakdown Crafting and Distributing the RFP (Government)

| | Time Elapsed (average) | |
|---|---|---|
| | Traditional | Process of the |
| Individual Steps Required | Process | Present Invention |
| Identify most recent RFP to use as | :05 | :02 |
| template | | |
| If not applicable, search for | :50 | :07 |
| relevant example | | |
| Edit and update example RFP letter | 1:35 | :17 |
| Manager received and approved RFP | 1:40 | :20 |
| Retrieve past mailing list and print | 1:50 | Automatic |
| enveloped | | distribution |
| Copy RFP letters for distribution | 2:00 | |
| Mail letters | 2:05 | |
| Call city executives to solicit best | 2:35 | |
| rate | | |
| Field financial information requests | 3:05 | |
| TOTAL ELAPSED TIME | 1:35 to 4:35 | :20 |

### RFP Underwriting & Response (Financial Institutions)

Time Elapsed (average)

| | Traditional | Process of the |
|---|---|---|
| Individual Steps Required | Process | Present Invention |
| Branch manager received RFP letter | :01 | |
| RFP sits in “to do” file (up to 3 | 12:01 | |
| days) | | |
| Branch manager searches for | 12:21 | |
| appropriate officer | | |
| Appropriate officer receives RFP | 36:21 | :01 |
| (interoffice vs. email) | | |
| Officer reads RFP and assesses | 36:26 | :06 |
| opportunity | | |
| Officer collects 3 years of | 36:56 | |
| financial data | | |
| Officer prepares data spread | 37:56 | |
| Officer evaluates fund balances | 38:01 | :11 |
| Officer evaluates cash flow | 38:11 | :21 |
| Officer evaluates essentiality | 38:21 | :22 |
| Officer evaluates ratio analysis | 38:26 | :27 |
| Officer reads financial statement | 38:46 | :47 |
| notes | | |
| Officer recommends and sends data | 39:16 | 1:02 |
| to credit | | |
| credit reviews package and | 39:21 | 1:22 |
| opportunity | | |
| Credit tests underwriting | 39:41 | 1:32 |
| Credit complies list of questions | 39:51 | 1:42 |
| for officer | | |
| Officer asks questions of government | 40:01 | 1:47 |
| All questions forwarded to all | | 1:52 |
| participating banks | | |
| Officer receives answers and shares | 40:16 | 2:07 |
| with credit | | |
| Credit obtains latest pricing info | 40:31 | 2:12 |
| Officer assists credit in obtaining | 41:01 | |
| pricing info | | |
| Credit and officer negotiate pricing | 41:16 | 2:04 |
| Response letter is typed and sent to | 41:36 | 2:07 |
| government | | |
| TOTAL ELAPSED TIME | 29:36 to 54:36 | 2:07 |

### Proposal Evaluation and Selection

| | Time Elapsed (average) | |
|---|---|---|
| | Traditional | Process of the |
| Individual Steps Required | Process | Present Invention |
| Government holds public openings of | :30 | :15 |
| RFPs | | |
| Comparative spreadsheet created | 1:15 | |
| Bids analyzed, kept or discarded | 1:20 | :20 |
| Recommendation is made by finance | 1:35 | :35 |
| officer | | |
| Recommendation is approved by | 1:45 | :45 |
| council | | |
| All bidders are notified | 2:15 | :46 |
| TOTAL ELAPSED TIME | 2:15 | :46 |

Financial products, as used herein, may refer to many different types of financial products, but are preferably primary transactions (i.e., products sold directly to the end-user by the issuing institution) as opposed to secondary transactions (i.e., products sold from one institution to another institution). Financial products may include: investment products, trustee products, financing products, depository products, employee retirement products, advisory products, and audit products. Investment products refer to products where principal is invested with an expectation of receiving a return. Examples of investment products include, but are not limited to, stocks, bonds, certificates of deposit (CD), government agency paper, annuities, notes (e.g., promissory and collateralized), commercial paper, life insurance, mutual funds, and the like. Preferably, these products include CDs, government agency paper, notes, and commerical paper. Trustee products refer to products or services involving a trustee. Examples of trustee products include, but are not limited to, agreements for safekeeping services (e.g., the trustee takes responsibility for assets (e.g., artwork, stock certificates, documents, notes and the like), and agreements to distribute funds and the associated record keeping. Financing products refer to products where monies are obtained with an expectation to pay for the use of those monies. Financing products may be equity or debt products. Examples of financing products include, but are not limited to, loans, notes (e.g., promissory or collaterized), lines of credit, term loans, commercial paper, bonds, equities, and the like. Preferably, these products include loans, notes (e.g., promissory or collaterized), lines of credit, term loans, commercial paper, and bonds. Depository products refer to agreements to receive monies and pay from those monies on demand, negotiable instruments. Examples of depository products include, but are limited to, checking accounts, savings accounts, treasury management services, and the like. Employee retirement products refer to products related to retirement funds. Examples of employee retirement products include, but are not limited to, 401ks, 457s, SEPs, SIMPLEs, IRAs, pensions, and the like. Preferably, these products include 401ks and 457s. Advisory products refer to products in which a client seeks advise on decisions and/or options related to selection, evaluation, execution of, procuring or investing funds, preferably execution of funds. Audit products refer to services related to auditing of accounting or other business systems, preferably accounting audits. In summary, this process is applicable to any type of financial product offered, where the product requirements must be outlined, credit information must be assessed, and product offerings must be compared and selected. For this reason, it should be obvious that the method of the present invention could be applied to financial products not specifically mentioned herein.

The present invention may be embodied in other specific forms without departing from the spirit or essential attributes thereof, and, accordingly, reference should be made to the appended claims, rather than to the foregoing specification, as indicating the scope of the invention.

I claim:

1. A method for an entity, the entity being a governmental or business entity, to procure a financial product from a financial institution comprising the steps of:
posting a request for a proposal (RFP) for the financial product of the entity to a website, the RFP having been authorized by the entity;
electronically notifying the financial institution that the RFP has been posted;
reviewing the RFP by the financial institution; and
electronically notifying the entity of a result of the review by the financial institution.

2. The method of claim 1 wherein posting the RFP to the website further comprises the steps of:
profiling the entity by obtaining information about the entity that may be utilized by the financial institution in making the financial institution's decision to offer the financial product to the entity;
providing a deal sheet, the deal sheet outlining the entity's need for the financial product; and
authorizing the posting of the RFP by an official of the entity.

3. The method of claim 2 wherein posting the RFP to the website further comprises the step of:
identifying at least one financial institution that will have access to the RFP posted at the website.

4. The method of claim 1 wherein reviewing the RFP by the financial institution further comprises the steps of:
retrieving the RFP from the website;
studying the RFP; and
deciding whether to offer the financial product to the entity based upon the study.

5. The method of claim 4 wherein studying the RFP further comprises the step of:
requesting additional information about the RFP.

6. The method of claim 1 wherein electronically notifying the entity of the result of the review by the financial institution further comprises the steps of:
assemblying an offer for the financial product by the financial institution in a format that facilitates review by the entity; and
presenting the formatted offer to the entity.

7. The method of claim 1 wherein the financial product being selected from the group consisting of investment products, trustee products, financing products, advisory products, depository products, employee retirement products, advisory products, and audit products.

8. A method for an entity, the entity being a governmental or business entity, to procure a financial product being selected from the group consisting of investment products, trustee products, financing products, advisory products, depository products, employee retirement products, advisory products, and audit products from a financial institution comprising the steps of:
posting a request for a proposal (RFP) for the financial product of the entity to a website, the RFP having been authorized by the entity, wherein posting further comprises the steps of profiling the entity by obtaining information about the entity that may be utilized by the financial institution in making the financial institution's decision to offer the financial product to the entity, providing a deal sheet, the deal sheet outlining the entity's need for the financial product, and authorizing the posting of the RFP by an official of the entity;
electronically notifying the financial institution that the RFP has been posted;
reviewing the RFP by the financial institution, wherein reviewing further comprises the step of retrieving the RFP from the website, studying the RFP, and deciding whether to offer the financial product to the entity based upon the study; and
electronically notifying the entity of a result of the review by the financial institution, wherein notifying the entity further comprises the steps of assembling an offer for the financial product by the financial institution in a format that facilitates review by the entity, and presenting the formatted offer to the entity.

9. A method for a governmental entity to procure a financial product from a financial institution comprising the steps of:
posting a governmental entity's request for a proposal (RFP) for the financial product to a website, the RFP having been authorized by the governmental entity;
electronically notifying the financial institution that the RFP has been posted;
reviewing the RFP by the financial institution; and
electronically notifying the governmental entity of a result of the review by the financial institution.

10. The method of claim 9 wherein posting the RFP to the website further comprises the steps of:
profiling the governmental entity by obtaining information about the governmental entity that will be helpful to the financial institution in making the financial institution's decision to offer the financial product to the governmental entity;
providing a deal sheet, the deal sheet outlining the governmental entity's need for the financial product; and
authorizing the posting of the RFP by an official of the governmental entity.

11. The method of claim 10 wherein posting the RFP to the website further comprises the step of:
identifying at least one financial institution that will have access to the RFP posted at the website.

12. The method of claim 9 wherein reviewing the RFP by the financial institution further comprises the steps of:
retrieving the RFP from the website;
studying the RFP; and
deciding whether to offer the financial product to the governmental entity based upon the study.

13. The method of claim 12 wherein studying the RFP further comprises the step of:
requesting additional information about the RFP.

14. The method of claim 9 wherein electronically notifying the governmental entity of the result of the review by the financial institution further comprises the steps of:
assembling an offer for the financial product by the financial institution in a format that facilitates review by the governmental entity; and
presenting the formatted offer to the governmental entity.

15. The method of claim 9 wherein the financial product being selected from the group consisting of investment products, trustee products, financing products, advisory products, depository products, employee retirement products, advisory products, and audit products.

16. A method for a governmental entity to procure a financial product being selected from the group consisting of investment products, trustee products, financing products, advisory products, depository products, employee retirement products, advisory products, and audit products from a financial institution comprising the steps of:
posting a governmental entity's request for a proposal (RFP) for the financial product to a website, the RFP having been authorized by the governmental entity, wherein posting further comprises the steps of profiling the governmental entity by obtaining information about the governmental entity that may be utilized by the financial institution in making the financial institution's decision to offer the financial product to the governmental entity, providing a deal sheet, the deal sheet outlining the governmental entity's need for the financial product, and authorizing the posting of the RFP by an official of the governmental entity;
electronically notifying the financial institution that the RFP has been posted;
reviewing the RFP by the financial institution, wherein reviewing further comprises the step of retrieving the RFP from the website, studying the RFP, and deciding whether to offer the financial product to the governmental entity based upon the study; and
electronically notifying the governmental entity of a result of the review by the financial institution, wherein notifying the governmental entity further comprises the steps of assembling an offer for the financial product by the financial institution in a format that facilitates review by the governmental entity, and presenting the formatted offer to the governmental entity.
